(19) United States
(12) Patent Application Publication
(10) Pub. No.: US 2024/0354686 A1
(43) Pub. Date: Oct. 24, 2024

(54) COGNITIVE INTEROPERABLE INQUISITIVE SOURCE AGNOSTIC INFRASTRUCTURE OMNI-SPECIFICS INTELLIGENCE PROCESS AND SYSTEM FOR COLLABORATIVE INFRA SUPER DILIGENCE

(71) Applicant: ASTRIKOS CONSULTING PRIVATE LIMITED, BENGULURU (IN)

(72) Inventor: Chinmaya Hegde, Benguluru (IN)

(21) Appl. No.: 18/684,649

(22) PCT Filed: Aug. 16, 2022
(86) PCT No.: PCT/IN2022/050737

§ 371 Date: Feb. 16, 2024

(30) Foreign Application Priority Data
Aug. 17, 2021 (IN) 202141022044

(51) Int. Cl. G06Q 10/067; G06Q 10/0633; G06Q 10/0639; G06Q 50/26

(52) U.S. Cl. CPC G06Q 10/067; G06Q 10/0633; G06Q 10/06393; G06Q 50/26

(57) ABSTRACT

The invention provides AI/Machine Learning frameworks i.e., a Workbench, (FIG. 2 (213)) with intelligences and modelling methods to address ‘What-If’ scenarios—(FIG. 2 (220)), users can devise specific studies (FIG. 3 (313)) with workbench to build and train models, ML workbench (FIG. 2 (213)) thus provides both domain-specific standard analytics as well as user-defined scenarios, while assisting the user to optimize their model performance, the seamless user Interface provides best-in-class visualization (FIG. 2 (226)) and dashboards (FIG. 2 (225)), while also enabling collaborative information specifics exchange (FIG. 9) and workflows across disciplines.

### CROSS-REFERENCE TO RELATED APPLICATIONS

This U.S. non-provisional application claims priority under 35 U.S.C. 371 to International Application No. PCT/IN2022/050737 with an international filing date Aug. 16, 2022 and a priority date of Aug. 17, 2021, the entire contents of which are hereby incorporated by reference.

### FIELD OF THE INVENTION

The present invention is related to “machine learning, deep learning and artificial intelligence based analytical platform” for processing of system agnostic collaborative information specifics derived from disparate systems such as Operation Technology (OT) systems, Information Technology (IT) systems, Internet of Things (IoT) systems and Internet of Everything systems, be it a machine or a platform or a process framework or any other intelligent system or manual system.

### BACKGROUND OF THE INVENTION

In the past few years, globally many smart devices are being interconnected and communicated through the existing internet infrastructure which form a global network infrastructure called the Internet of Things (IoT). Studies have shown that there is substantial development and solutions are being introduced for a wide range of devices and platforms in the field of Information Technology (IT), Operational Technology (OT) and Internet of Things (IOT) over the past decade.

However, each solution offers its own IoT infrastructural, devices, APIs, data sharing methods and data formats resulting in interoperability issues. Such interoperability issues are the consequences of many critical issues such as vendor lock-in, impossibility to develop universal application exposing cross-platforms, and/or across-domains, difficulty in plugging non-interoperable IT/OT/IOT devices into different platforms, and ultimately prevents the emergence of unified technology at a large-scale. To enable seamless resource sharing between different source applications and devices, efforts by several academia, industry, and standardization bodies have emerged to help IT/OT/IOT interoperability, i.e., the ability for multiple platforms from different applications to work together. Hence there is a need for developing a platform to address existing state-of-the-art solutions for facilitating interoperability between different domains, applications, infrastructure and devices.

A unified analytics system enables organizations to aggregate information specifics to monitor, analyse, manage, and prescribe smart infrastructure strategies across a variety of data sources, systems, and communication protocols. Such a decision support system must work with distributed data both structured and unstructured—with scalable data storage and extensible service-oriented architecture. To gain insights from such data, the system must use advanced intelligence models to uncover hidden patterns, trends, and correlations. The platform must be interactive to accept multi-dimensional user-defined data sources, present alternatives for intelligent processes, automate the analytics from data input to results visualization, and provide feedback through prescriptive advisories and alerts for optimization and situational response.

Such a platform needs to possess capability of omni-information specifics intelligence in order to process data mining and analysing of even the agnostic data patterns also. Data mining involves various sources-structured and/or unstructured-such as process historian [continuous] time series, and/or discrete events, which must be analysed to derive context-based insights in real-time. This is cross-disciplinary analytics. Finally, the results must be available on intelligent dashboards to enable multiple stakeholders to execute effective systems response and strategic decisions for optimized infrastructural operations. This is cognitive ‘intelligence-enabled system controls and prescriptive optimization’, which is the key innovation of “Cognitive Interoperable Inquisitive Source Agnostic Infrastructure Omni-Specifics Intelligence System for Collaborative Infra Super Diligence”

In the IT/OT/IOT enabled scenario, collaboration using a variety of communication mediums and protocols is imperative for effective infrastructure monitoring and response. At the same time, sustainability and emergency response, disaster preparedness and operational efficiency are key mandates across industrial domains, government, infrastructure, and citizen services platforms—where KPIs must be complied with, while addressing complex multi-disciplinary optimization trade-offs.

### PRIOR ARTS

U.S. Pat. No. 9,438,648: —The patent deals with the cloud-based data analytics for management and control of industrial assets and aids the management for real time decision making. The Cloud-aware industrial devices feed robust sets of data to a cloud-based data analyzer that executes as a service in a cloud platform. In addition to industrial data generated or collected by the industrial devices, the devices can provide device profile information to the cloud-based analyzer that identifies the device and relevant configuration information. The industrial devices can also provide customer data identifying an owner of the industrial devices. The cloud-based data analyzer leverages this information to perform a variety of custom analytics on the data and generate reports or notifications, and enable to perform real-time decision making and control.

US20020091990A1: —The patent is about a system for integrated computer software application development and modelling. The integrated system includes an expert system that can be supplied as a software plug-in to assist a software developer in designing and constructing software applications using uniform modelling language (UML) object modelling. In one embodiment the plug-in works with Rational Software Corporation's Rational Rose modelling product and can be used to develop software applications for use with M3 and the Web-logic family of transaction and application server products from BEA Systems, Inc, and with other third-party software systems.

US20170006141A1: —The patent deals with systems and methods to leverage and manage data and knowledge in a M2M or Internet of Things (IoT) network. More particularly, its a cognitive intelligence platform for an IoT network that provides autonomic decision support system at or near real-time and executes a dynamic runtime is provided. The hardware, software and communication design of the platform replicates the structural and operational model of the human nervous system to achieve cognitive intelligence through adaptation, collaborative learning, knowledge sharing and self-adjustment.

US20170011298A1: —The patent is about a computer implemented method and system for determining reliability of a machine. It comprises of receiving machine data from one or more locations through an internet of things (IOT) based machine wearable sensor network. The method further includes storing the data in a distributed computer database communicatively coupled to an enterprise resource planning (ERP) system and extracting one or more entity information, through a computer server to compare the data against a pre-defined baseline. Further, mapping, though a big data machine learning engine, the extracted one or more entity information into a multi-classification model. The method includes indicating, through a machine learning engine coupled to a predictive analytics engine, on a user interface a set of analytical predictions for machine maintenance, repair and operation.

US20170053242A1: —The patent is a method and system for providing big data analytics framework for predictive and qualitative analysis for application developers, data scientists and system engineers without having technology specific programming experience. Further the framework contains adapters for the software engineers to configure the big data hub, wherein these software engineers can easily share, store, process and predict functionalities with the data scientists and user interface (UI) developers.

Indian patent application No. 202111027550: —The patent deals with the process of transformation of power grids into Smart Grids by finding ways to penetrate with smart devices in the existing power systems and also establish means of communication. In Smart Grid, power systems are integrated with Information and Communication Technology which has enabled distributed controls and real time services by the fusion of these technologies. The invention integrates algorithms of Artificial intelligence and real-world wireless communication systems such that real time design requirements of Smart Grid is met. The proposed architecture has the reconfiguration property based on the network of wireless communication and advanced technologies of ICT which includes Machine Learning algorithm.

Indian patent application No. 202111027614—the invention is titled as “system and method for IoT based controlling and monitoring of smart city”, it provides a system and method pertaining to Internet of Things (IoT) based water logging status notification. The image sensor captures image of a marker that indicates water level at a specific location. The captured image is segmented, processed and then compared with images indicating threshold level, beyond which waterlogging is determined. Determined waterlogging status along with marker location can be transmitted, over a communication network, to electronic devices associated with concerned authorities

Literature—It's an article on machine learning and data analytics on Internet of Things (IoT) devices, which have grown in exorbitant numbers, generating a large amount of data required for intelligent data processing. However, the varying IoT infrastructures (i.e., cloud, edge, fog) and the limitations of the IoT application layer protocols in transmitting/receiving messages become the barriers in creating intelligent IoT applications. These barriers prevent current intelligent IoT applications to adaptively learn from other IoT applications. The paper, critically review how IoT-generated data are processed for machine learning analysis and highlights the current challenges in furthering intelligent solutions in the IoT environment. Finally, it discusses the key factors that have an impact on future intelligent devices for the IoT.

### Drawbacks Present in Prior Art

There is a lacuna in current smart infrastructure platforms where IT/OT/IoT applications and equipment is not fully integrated for seamless operational intelligence. This gap must be addressed with an integrated analytics solution where information specifics from diverse operational equipment needs to be extracted to yield actionable insights and advisories for stakeholders across functions/domains-a key requirement for smart infra such as in smart cities, data centres, urban/rural infrastructure, campuses, sea/air-ports, rail networks, energy/utilities, or industries etc.

Current platforms lack a seamless and interactive user interface for Visual Analytics and absence of decision support under uncertainty is a major drawback since they are largely transactional, and do not provide insights into unknown scenarios.

The present platforms suffer from lack of benchmark data sets in operational technology and cannot enable analytics across cyber-physical operations and fail to provide comprehensive portfolio to mine raw analogue data and provide insights as well as advisories in response to events.

Also, it does not address all the complexities of cross-system interactions and heterogeneity of information specifics, which requires wide array of protocols for communication, it suffers from lack of correlative analytics across disparate IT/OT/IOT derived information specifics streams and across stakeholders, where both operational equipment (OT) and ICT infrastructure, must be concurrently monitored and managed.

And lastly current platforms do not have the capability to assess nor enable compliance watch guarding and auditing to global standards such as sustainability metrics, ISO frameworks, World Council for City Data (WCCD), LEED, WELL, United Nations-Sustainable Development Goals, which is key to infrastructure optimization

### Necessity for New Invention

There is a need for a smart interoperable analytical platform for mining and analysis of information specifics from disparate systems through predictive and preventive models to solve the challenges of multi-disciplinary optimization across domains by seamlessly mining a combination of IT & OT data as explained above:

This clearly demands a solution for two major problems in this field, one problem is how to harness the increasing volume, variety, and velocity of unstructured data is not only how to harness the huge data for insights (what happened and how) on cause-effect relationships, but more importantly, how to predict trends and prescribe optimal response strategies to events before they occur.

Another problem to be addressed is real-time situational response strategies and automated intelligent advisories with collaborative workflows, where events can trigger alerts and work orders and raise context-sensitive intelligent alarms and online real-time information exchange, resulting in quick decisions and optimal cross-functional response.

Hence the invention addresses the requirement of users and organizations by providing a unified context-driven analytics platform which provide actionable insights in three dimensions ICT-enabled, IOT-connected, and operational equipment performance and thus handles seamlessly ingested unstructured raw data using multiple different communication modalities, along with advanced Machine Learning models and cognitive intelligence.

Additionally, the invention provides automated collaborative workflow mechanisms for effective operational response strategies by developing multi-disciplinary AI/ML platforms to accelerate predictive and prescriptive insights, to enable cross-disciplinary decision support workflows, and optimize cyber-physical infrastructure with converged IT-OT-IOT analytics.

### SUMMARY OF THE INVENTION

An inventive concept is to provide information specifics-agnostic analytics across cyber-physical infrastructure i.e. the IT-OT-IoT landscape—by deriving tangible insights and prescriptive advisories for effective command and control operations. Predictive and Prescriptive analytics are the key objectives of this ML platform

An inventive concept is to provide a collaborative operational intelligence platform for processing data input and integration from diverse sources, analytics using Machine Learning models, and prescriptive insights for decision support and operational response strategies

An inventive concept is to develop smart interoperable analytical platform which can handle high volume, variety, and velocity of heterogeneous unstructured data operating on multiple protocols.

An inventive concept is to provide scalable and extensible collaborative platform to concurrently mine raw analogue IT and OT data (not depending on hardware accelerators or processing power) for multiple data science users across domains i.e. cyber-physical operations

An inventive concept is to develop an AI-enabled but human-in-loop real-world collaborative platforms for providing decision support under uncertainty by mining data for insights into unknown scenarios.

An inventive concept is to provide a seamless collaborative and interactive user interface for Visual Analytics—that simplifies analytics operations while providing insights on user-defined dashboards as well as advisories in response to events

An inventive concept is to address complexity of cross-system interactions and heterogeneity of information specifics which requires wide array of protocols for communication

An inventive concept is to develop a platform which matches the compliance requirement of global standards

### STATEMENT OF THE INVENTION

It will be understood that this disclosure is not limited to the particular systems and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

The invention provides a state of art technological solution to handle complex mix of software applications, hardware input and output components which are IT/OT/IOT enabled. The solution is developed on a platform which is capable of interoperability and contains combination of analytical models (which may be standard or customized), and deals with machine learning aspects which in turn enhances the cognitive ability of the platform and aids and support AI, and thus capable of providing smart solutions to variety of service applications in the field of Civil & Administrative services. Manufacturing industries, Datacentre management and for handling public health and emergencies through crisis control, response and mitigation system.

### Utility and Application of the Technology: —

The invention has ample utility value and is capable of providing smart solutions to variety of service applications such as:
i. Civil services: helps urban administrators to assess their readiness for global smart cities standards (World Council for City Data-WCCD, ISO. etc.),
ii. Industries and Campuses: AI/ML based administrative/KPI analytics platform for industries/factories etc. Also, help the administrators to meet and maintain the global manufacturing standards such as World Class Manufacturing (WCM compliance)
iii. Data Centres and Buildings: AI/ML based operations KPI analytics platform for Data Centres, which can also help the administrators to estimate their progress of meeting global standards such as LEED, ISO for factories KPIs and energy management systems, WELL, Green building coefficients and metrics etc.,
iv. Emergencies: Crisis Control, Response and Mitigation System for various crisis scenarios

### BRIEF DESCRIPTION OF DRAWINGS

The accompanying drawings describe the invention in greater detail containing same reference numbers across figures to refer to like parts, devices, equipment or components.

FIG. 1. shows a block diagram of four major stages of the entire concept from input to output

FIG. 2. shows the detailed work flow process of a cognitive interoperable inquisitive source agnostic infrastructure omni-specifics intelligence system in accordance with an embodiment of the inventive concepts.

FIG. 3. shows the flow chart of agnostic input data analysis and modelling in accordance with an embodiment of the inventive concepts.

FIG. 4 shows process flow chart of stage 1 of an embodiment of the inventive concepts that is agnostic input data processing.

FIG. 5 shows process flow chart of stage 2 of an embodiment of the inventive concepts that is analysis and modelling.

FIG. 6 shows process flow chart of stage 3 of an embodiment of the inventive concepts that is model testing and evaluation process.

FIG. 7 shows process flow chart of stage 4 of an embodiment of the inventive concepts which depicts various output scenarios

FIG. 8 shows process flow chart illustrating the capability of an inventive concept for Process Automation on real time workflows for infrastructure monitoring and operation, infrastructure resource mobilization, and automated information exchange across machines and human resources, to enable different agencies to collaborate online in accordance with an embodiment of the inventive concepts.

FIG. 9 shows process flow chart illustrating the capability of an inventive concept for Accurate analysis using Machine Learning models involving cross-domain collaborations in accordance with an embodiment of the inventive concepts.

FIG. 10 shows process flow chart indicating input-process-output corresponding to an OT Infrastructure in accordance with an embodiment of the inventive concepts.

FIG. 11 shows process flow chart indicating input—process—output corresponding to IOT Infrastructure such as Data centres, BMS etc in accordance with an embodiment of the inventive concepts.

FIG. 12 shows process flow chart indicating-input-process-output corresponding to IT Applications in accordance with an embodiment of the inventive concepts.

FIG. 13 illustrates process flow of Data Centre operations through AI/ML based cognitive capabilities of the invention through its Smart Interoperable Analytical platform in accordance with an embodiment of the inventive concepts.

FIG. 14 illustrates process flow for Emergencies: Crisis Control, Response and Mitigation System for various crisis scenarios in accordance with an embodiment of the inventive concepts.

FIG. 15 illustrates the screen shot of the intelligent dash board for civil services under smart city project thus derive actionable insights for effective decision support and situational response in accordance with an embodiment of the inventive concepts.

FIG. 16 illustrates the screen shots of the intelligent dashboard of one part for the various services covered under smart city project indicating the service efficiency as against the standards in accordance with an embodiment of the inventive concepts.

FIG. 17 illustrates the screen shots of the intelligent dashboard of additional services covered under smart city project indicating the service efficiency as against the standards in accordance with an embodiment of the inventive concepts.

FIGS. 18A & B illustrates the screen shots of the intelligent dashboard for the forecast of energy consumption predicted based on weather conditions such as ambient temperature and wind chill (cooling needs) respectively in accordance with an embodiment of the inventive concepts.

FIG. 19 illustrates the screen shots of the intelligent dashboard for the services covered under smart city project indicating the parameters covered under smart bus system in accordance with an embodiment of the inventive concepts.

FIG. 20 illustrates the screen shots of the intelligent dashboard of unified operations and management platform for environment monitoring covering Ambient Air Quality parameter readings as against the standards in accordance with an embodiment of the inventive concepts.

FIG. 21 illustrates the screen shots of the intelligent dashboard for the Crisis Control and Response Mitigation System pertaining to healthcare emergency. displaying ward wise covid patients details with ranges determining Red, Orange, Yellow and Green respectively in accordance with an embodiment of the inventive concepts.

FIG. 22 illustrates the screen shots of the intelligent dashboard indicating ward wise patent details for the Crisis Control and Response Mitigation System pertaining to health care emergency in accordance with an embodiment of the inventive concepts.

FIG. 23 illustrates the screen shots of the intelligent dashboard for the Crisis Control and Response Mitigation System pertaining to health care emergency preparedness such as planning the sanitation spraying, availability of beds in various hospitals, health kits, ambulances etc. in accordance with an embodiment of the inventive concepts,

FIG. 24 illustrates the screen shots of the intelligent dashboard for the forecast and prediction of air quality due to vehicular traffic by comparing the actual readings against the predicted readings in accordance with an embodiment of the inventive concepts.

### DESCRIPTION OF THE INVENTION

The present disclosure relates to the branch of engineering which involves Machine learning which happens to be the subset of AI (Artificial Intelligence). Machine learning is an application of artificial intelligence that provides systems with the ability to automatically learn and improve from experience without being explicitly programmed

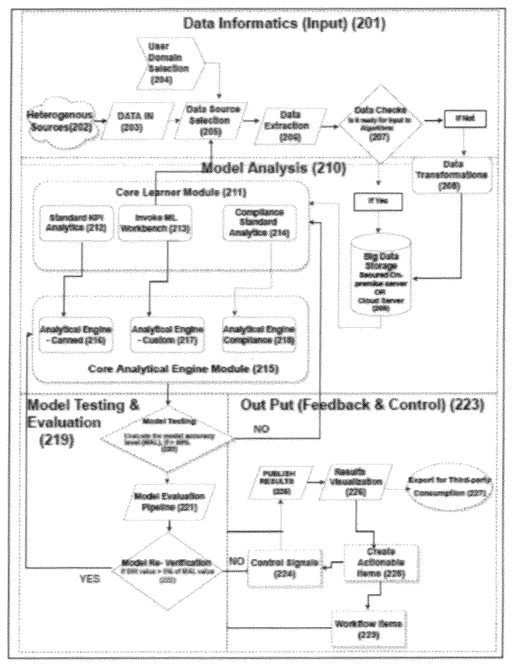

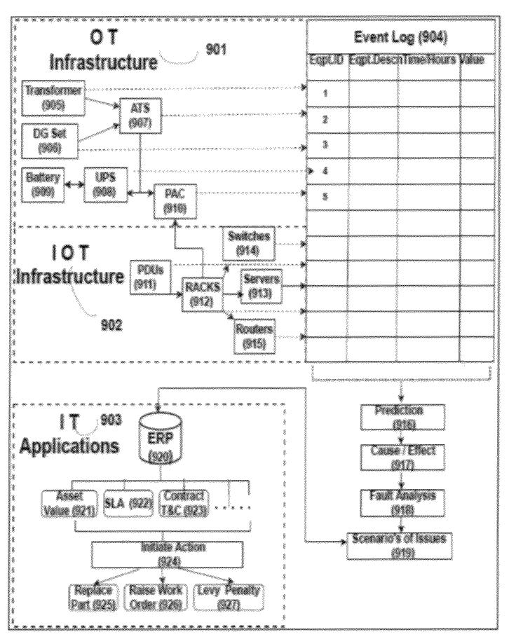

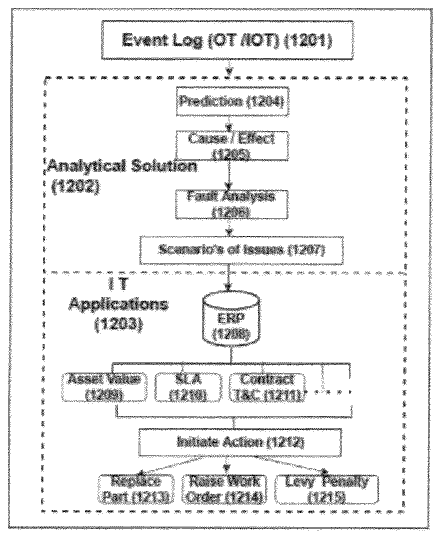

The invention addresses the requirement of users and organizations by providing a unified context-aware IoT-based analytics platform (FIG. 12) which provide actionable insights on both ICT (information and communication technology)-enabled and operational equipment performance and thus handles seamlessly ingested unstructured raw data using multiple different communication modalities, along with advanced Machine Learning models and cognitive intelligence. (FIG. 2) Additionally, it provides automated collaborative workflow mechanisms for effective operational response strategies by developing multi-disciplinary ML platforms to accelerate predictive and prescriptive insights, to enable cross-disciplinary decision support workflows, and optimize cyber-physical infrastructure with converged IT (information technology)/OT (operational technology)/IOT (Internet of things) analytics (FIG. 9)

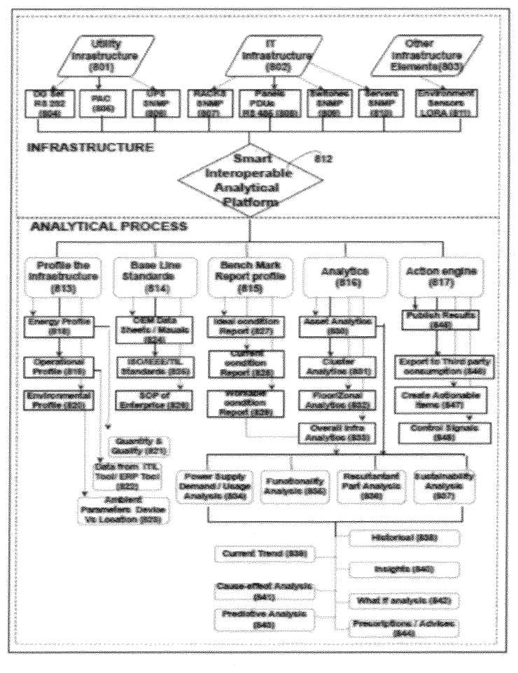

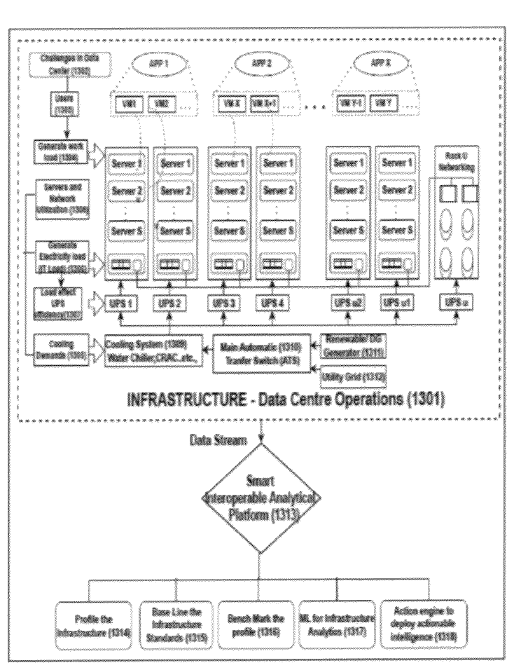

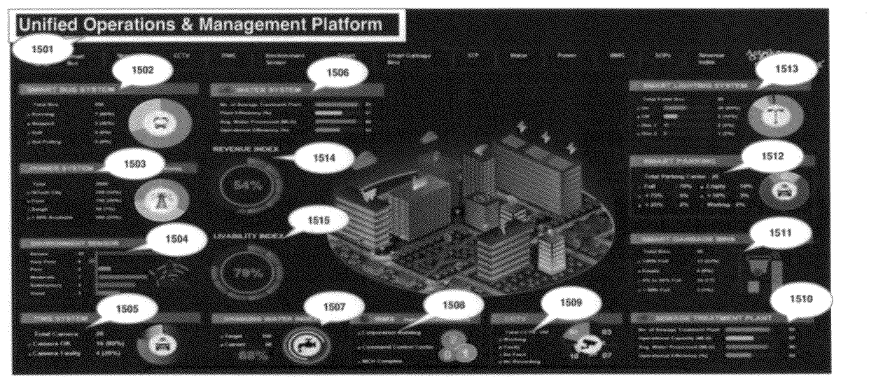

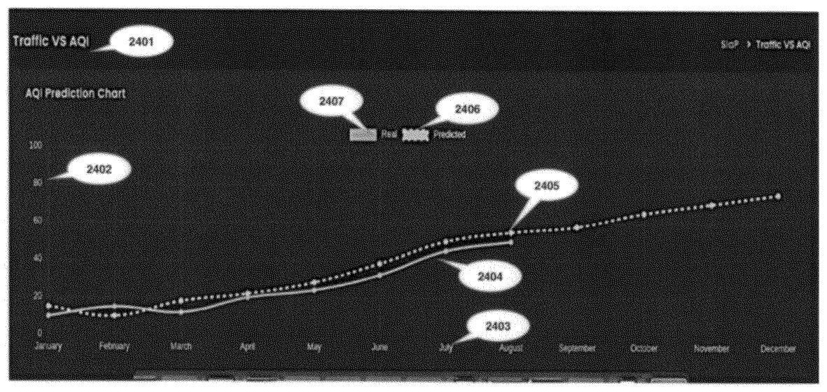

The invention is a collaborative, interoperable cognitive intelligence platform for disparate data, provides advanced models and intelligent dashboards to (a) manage and monitor cyber-physical equipment, (FIG. 13) (b) derive insights and hidden trends and patterns, (FIG. 15) and (c) predict possible scenarios and prescribe optimization strategies. (FIG. 24) This is achieved with a variety of communication protocols and models to optimize infrastructure while automating situational monitoring and response workflows (FIG. 8).

Predominantly it is a Machine Learning platform through which it extracts information specifics from cyber-physical infrastructural elements, using advanced cognitive intelligence and models to (i) analyse multi-dimensional inputs and (ii) provide actionable insights and prescriptive advisories for effective decision support and operational response strategies (FIG. 8).

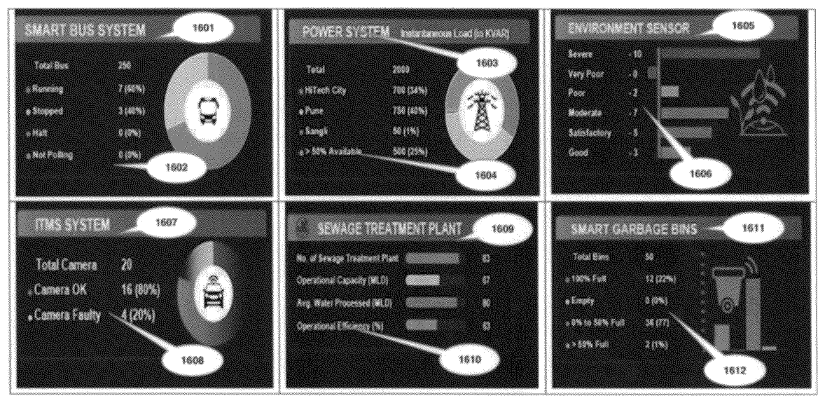

The invention provides Machine Learning frameworks (FIG. 2) i.e., a Workbench, with cognitive intelligence and modelling methods to address ‘What-If’ scenarios (FIG. 2 (207), (220) (222))—users can devise specific studies with workbench to build and train models. ML workbench (FIG. 2 (213)) thus provides both domain-specific standard analytics (FIG. 2 (212)) as well as user-defined scenarios (FIG. 2 (217)), while assisting the user to optimize their model performance. The seamless User Interface provides best-in-class visualization (FIG. 2 (226), FIGS. 15, 16 & 17)) and dashboards, while also enabling collaborative specific information exchange and workflows across disciplines. The innovation based on self-comparative models of process and technical frameworks covers, pre-defined canned analytics (FIG. 2 (216)), user defined analytics (FIG. 2 (217)) and also standard compliance analytics (FIG. 2 (216)).

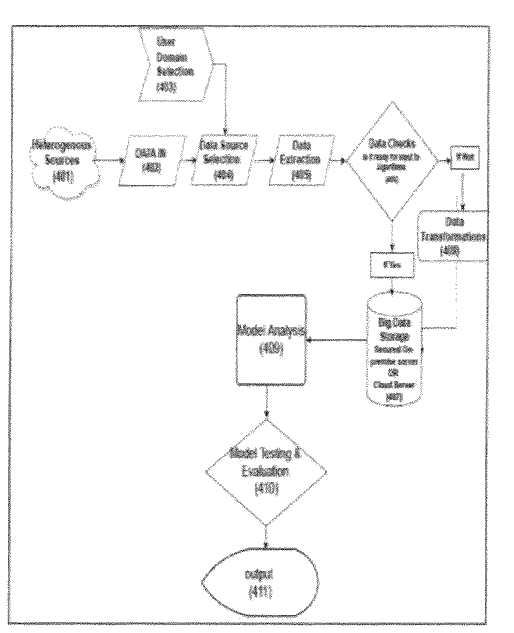

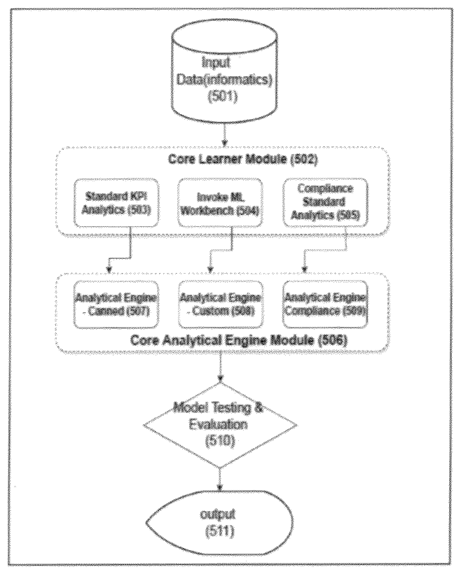

The major processes of the invention comprise domain selection (FIG. 2 (202 to 204), source selection (FIG. 2 (205) & FIG. 4 (405)), extraction (FIG. 2 (206) & FIG. 4 (406)), checking (FIG. 2 (207) & FIG. 4 (407)), transformation (FIG. 2 (208) & FIG. 4 (408)) and cleansing, big data storage (FIG. 2 (209) & FIG. 4 (409)), invoking of machine learning work bench (FIG. 2 (211) & FIG. 5 (502)), Analysis of models (FIG. 2 (215) & FIG. 5 (506)), model testing and acceptance (FIG. 2 (219) & FIG. 5 (510)) and finally result visualization. (FIG. 2 (226)).

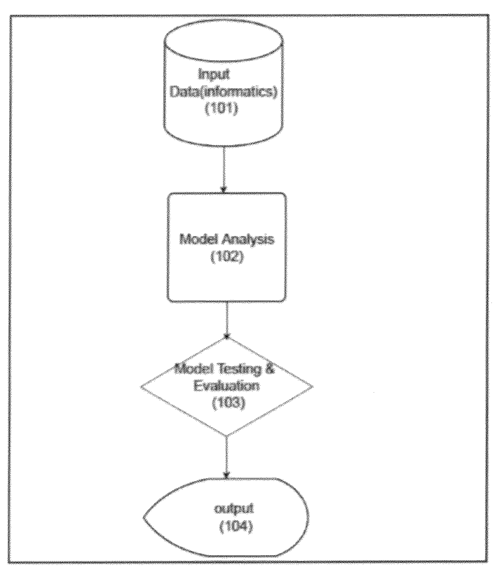

The entire concept of the invention operates like a closed loop control system, comprising input (FIG. 1 (101)—process (FIG. 1 (102 & 103))—output (FIG. 1 (104)) which is governed by a feedback sequence which acts as a control and governs the entire operation. FIG. 1 shows a block diagram of four major stages of the entire concept from input to output. The input components consist of domain selection and information specifics source selection (FIG. 1 (101)) which is predominantly handled by the users themselves and the feeding of the information specifics is done through any of the standard input devices such as keyboard, scanner, camera, sensors, or any other sources. The Input data is further analysed (FIG. 1, (102)) and are segregated as per specific models, the analysed models are evaluated and tested (FIG. 1. (103)) with is machine learning capabilities of the platform and finally processed data in the form of results or output (FIG. 1 (104)) is displayed through intelligent dashboards where user can interactively choose their parameters of interest.

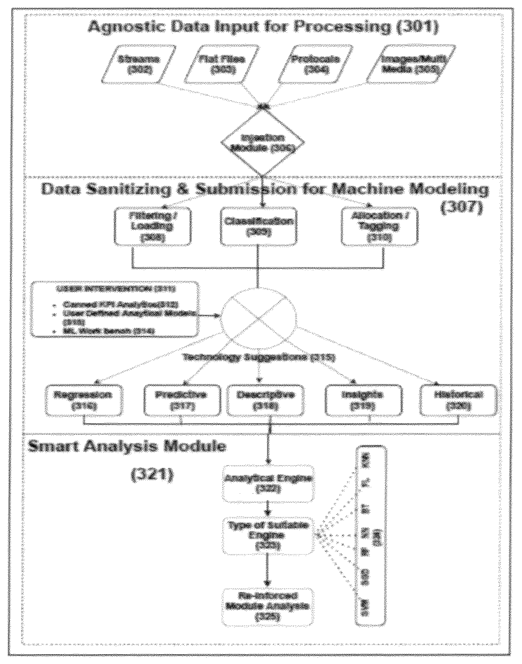

(FIG. 3 (306)) from a variety of sources, (FIG. 2 (202) and FIG. 3 (301)) this input uses multiple protocols (FIG. 2 (204)) as the cognitive interoperable intelligence platform can handle diverse data formats. The system developed intelligence primarily extracts the data sources (FIG. 2 (206)) and checks (FIG. 2 (207)) whether it is ready to input and ascertain suitability for processing, in case if the input is distorted or disturbed with noise, the system undertakes cleansing action (FIG. 3 (308 to 310)) and finally the clean and transformed information specifics (FIG. 2 (208)) is stored in big data storage (FIG. 2 (209)) which may be a secured server or a cloud store.

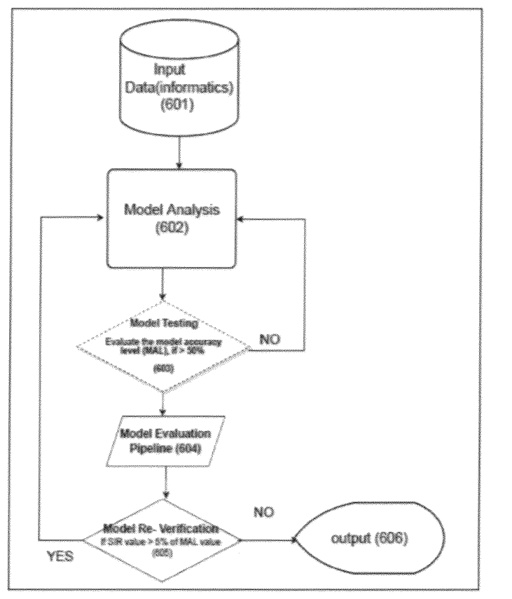

Further the data is engineered for specific features and relevant use cases based on the domain of applicability. This is the first stage of the ML (Machine Learning) workbench process (FIG. 2 (211) & FIG. 5 (502)). The core processing involves various operations such as feature engineering (FIG. 2 (215) & FIG. 5 (506)), intelligence selection and user defined studies take place, the processed information specifics from the ML work bench passes into analysis pipeline (FIG. 2 (219) & FIG. 6 (602)) wherein operations such as model definition, input training, method selection, and multiple iterations are submitted to fine tune the model

The core ML pipeline (FIG. 2 (219) & FIG. 6 (602)), from designing the user cases and metrics of the analysis, to defining the appropriate models and cognitive intelligence for the specific domain, and enabling the user to choose either pre-defined or specific experiments to be run, and defining the test and training specifics (FIG. 2 (220) & FIG. 6 (603)), are the essential functions enabled in this step. This is where complex scenarios are defined and the model is fine-tuned for specific parameters of interest.

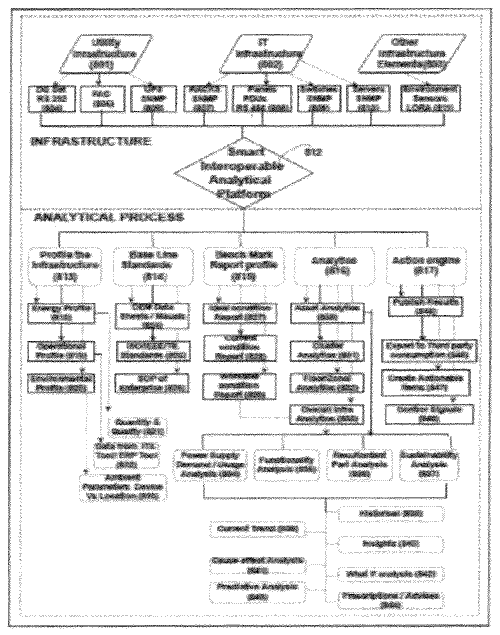

The fine-tuned and processed information specifics model undergoes testing and acceptance process (FIG. 2 (221 & 222) & FIG. 6 (604 & 605)) before it is let out for result visualization (FIG. 2 (226) & FIG. 7 (705)) which is the output of the system. The result visualization can be a dashboard for analysis (FIG. 2 (225) & FIG. 7 (704)), results for user defined studies, a standard domain specific metrics or it can give options for correlative, predictive or prescriptive studies (FIG. 2 (227) & FIG. 7 (706)).

Finally, results are output in intelligent dashboards (FIG. 2 (226) & FIG. 7 (705)) where user can interactively choose their parameters of interest. These dashboards also provide actionable alerts (FIG. 2 (228) & FIG. 7 (707)) and insights for further operational strategies (FIG. 2 (224) & FIG. 7 (708)).

The master process flow of the invention is shown in FIG. 2 (201 to 229) which illustrates detailed work flow process of the invention, being cognitive interoperable inquisitive source agnostic infrastructure omni-specifics intelligence system is illustrated in the flow chart of Figure: 2 (201 to 229) The process stages and the sequential methods are explained in the following para:

Information specifics from various heterogenous sources (FIG. 2 (202) & FIG. 4 (401)) is received through permissible access and security protocol and is let in (FIG. 2 (203) & FIG. 4 (402)) for further processing, simultaneously the user having the platform access undertakes domain selection (FIG. 2 (204) & FIG. 4 (403)) and chooses appropriate domains such as smart infra (smart city), smart data centre or smart industry application, further to it the user selects the relevant data sources (FIG. 2 (205) & FIG. 4 (404)) to input for analytics. Once the domain and specifics selection are undertaken the system connects to the relevant data sources and the data is extracted (FIG. 2 (206) & FIG. 4 (405)) On completion of the data extraction (FIG. 2 (206) & FIG. 4 (405)) process, the extracted data undergoes inspection (checking) process (FIG. 2 (207) & FIG. 4 (406)) in this the data is checked for its readiness for input to cognitive Intelligence, if ready the data is stored in Big. data (FIG. 2 (209) & FIG. 4 (407)) storage which might be secured on premise server or cloud server. If the data is not ready it undergoes transformation process (FIG. 2 (208) & FIG. 4 (408)) which consists of data cleansing, pre-processing process comprising of extraction, transformation and loading, in this process data from various sources is transformed in to the information in specific format in line with needs and finally the information is loaded into a destination database.

FIG. 3 (301 to 325) illustrates the flow chart of agnostic input data analysis and modelling process which mainly comprises of three stages such as (i) Agnostic data input processing (FIG. 3 (301)) (ii) data sanitizing & submission for machine modelling (FIG. 3 (307)) and (iii) smart analytical module (FIG. 3 (321)) respectively. The agnostic data input (FIG. 3 (301)) from various sources such as streams (FIG. 3 (302)), flat files (FIG. 3 (303)), protocols (FIG. 3 (304)), images and multimedia (FIG. 3 (305)) are subjected to ingestion modelling process (FIG. 3 (306)), further ingested data undergoes sanitizing process which comprises of filtering and loading (FIG. 3 (308)), classification (FIG. 3 (309)), allocation and tagging (FIG. 3 (310)) respectively. The sanitized data is subjected to machine modelling (FIG. 3 (307)) the process is called core leaner module comprising of user intervention (FIG. 3 (311)), canned KPI analysis (FIG. 3 (312)), user defined analytical modules (FIG. 3 (313)) and ML workbench (FIG. 3 (314)). The analytical machine modelling process involves technological suggestions (FIG. 3 (315)) which in turn comprises of statistical analytical processes such as regression (FIG. 3 (316)), predictive analysis (FIG. 3 (317)), descriptive analysis (FIG. 3 (318)), actionable insights (FIG. 3 (319)) and study of historical data (FIG. 3 (320)) respectively. Further to machine modelling the informatics is subjected to smart analytical module (FIG. 3 (321)) creating process, in this, the process comprises of analytical engine (FIG. 3 (322)), selection of specific type of suitable engine (FIG. 3 (323)) from the array of programs (FIG. 3 (324)) and reinforced module analysis (FIG. 3 (325)) respectively.

The information specifics from the Big Data storage (FIG. 2 (209) & FIG. 4 (407)) is subjected to two major process modules (FIG. 2 (210)) of the smart inter operable analytical platform, such as “core learner module” (FIG. 2 (211) & FIG. 5 (502)) and “core analytical engine module” (FIG. 2 (215) & FIG. 5 (506)). The core learner module (FIG. 2 (211) & FIG. 5 (502)) comprises of three analytic techniques such as standard KPI analytics (FIG. 2 (212) & FIG. 5 (503)), ML workbench (FIG. 2 (213) & FIG. 5 (504)) and compliance standards analytics (FIG. 2 (214) & FIG. 5 (505)) etc., Activities under standard KPI analytics consists of carrying out pre-operations by arranging ML based analytics on industry standard KPIs (FIG. 2 (212) & FIG. 5 (507)) according to the relevance to the respective infrastructure such as smart cities, data centres, and industries etc., The process under ML work bench (FIG. 2 (213) & FIG. 5 (508)) involves activities such as carrying out pre-operation, feature engineering, intelligence selection and user defined studies etc., The third process under core learner module (FIG. 2 (211) & FIG. 5 (502)) comprises pre-operation, ML based analytics for various standard compliances (FIG. 2 (214) & FIG. 5 (505)) such as ISO, LEED, WELL, WCM, Tier-Standards, IEEE etc.

The second major process module of the platform, core analytical engine module (FIG. 2 (215) & FIG. 5 (506)) comprises of three analytical engine modules for canned (FIG. 2 (216) & FIG. 5 (507)), custom (FIG. 2 (217) & FIG. 5 (508)) and compliance (FIG. 2 (218) & FIG. 5 (509)) respectively. Analytical engine for canned consists (FIG. 2 (216) & FIG. 5 (507)) of model definition, system Input of training, comparative analytics to compliance standards/benchmark values, predict and also harness prescriptions to improvements and multiple iterations to fine tune the model to get the optimal and accurate values. Secondly analytical engine for custom (FIG. 2 (217) & FIG. 5 (508)) consists of user Input of training specifics, system suggests model definition, method selection by user and submitting of multiple iterations to fine tune the model, finally deployment to database or export result, The third analytical engine for compliance consists of model definition (FIG. 2 (218) & FIG. 5 (509)), system input of training information specifics, “What-if” simulators, comparative analytics to past models, predictive models for future values and multiple iterations to fine tune the model.

After undergoing the two core modules of core learner (FIG. 2 (211) & FIG. 5 (502)) and core analytical engine (FIG. 2 (215) & FIG. 5 (506)) the information specifics are further processed for model testing and evaluation (FIG. 2 (219) & FIG. 6 (602)) in which the information specifics is subjected to model testing (FIG. 2 (220) & FIG. 6 (603)), model evaluation (FIG. 2 (221) & FIG. 6 (604)), model re-verification (FIG. 2 (222) & FIG. 6 (605)), publishing of results (FIG. 2 (225) & FIG. 7 (704)) and finally the output in the form of information specific visualization (FIG. 2 (226) & FIG. 7 (705)) is made available. Under model testing process (FIG. 2 (220) & FIG. 6 (603)) evaluation of model takes place, if the model accuracy level (MAL) score is 50% and above the information specifics is evaluated through model evaluation pipeline (FIG. 2 (221) & FIG. 6 (604)), If the MAL is less than 50% the information specifics is sent back for reworking to core learning module (FIG. 2 (211) & FIG. 5 (502)). The evaluation in model evaluation pipeline comprises of activities such as model verification with reverse traversal, comparative checks with benchmark value and comparative analysis with industry standards and finally estimation of scope for improvement rate (SIR).

The process involved in model re-verification (FIG. 2 (222) & FIG. 6 (605)) is subjecting the models to undergo further evaluation through comparative analysis of scope for improvement rate (SIR) with module accuracy level (MAL), If SIR value is >5% than MAL value then the specifics is passed back to standard KPI analytics stage (FIG. 2 (215) & FIG. 5 (506)) once again for secondary processing on the other hand if the SIR value <5% of the MAL value the results are published (FIG. 2 (225) & FIG. 7 (704)). Once the results are published the process enters the final leg that is result visualization (FIG. 2 (226) & FIG. 7 (705)) process which may comprise of any of these forms of output such as dashboards for analysis (FIG. 2 (225) & FIG. 7 (704)), results of user-defined studies or standard domain-specific metrics (FIG. 2 (227) & FIG. 7 (706)), or options for correlative, predictive or prescriptive studies and these work flow items can be further processed for controlling machinery/equipment (FIG. 2 (224) & FIG. 7 (708)) and any of the process engineering requirement. These outputs can be utilized to create actionable items (FIG. 2 (228) & FIG. 7 (707)) such as workflow items (FIG. 2 (229) & FIG. 7 (709)) and may be sent back to publish results (FIG. 2 (225) & FIG. 7 (704)), on the other hand these outputs may also be converted in the form of control signals (FIG. 2 (224) & FIG. 7 (708)) for the optimization of the machinery or machine process intervention to enhance the output accuracy and the performance and can be further sent back to publish results (FIG. 2 (225) & FIG. 7 (704)) again or these outputs can also be exported for third-party requirements (FIG. 2 (227) & FIG. 7 (706)) such as instrumentation/hardware/software./electronic systems consumption.

FIG. 8 (801 to 848) illustrates the capability of the invention for Process Automation on real time workflows for infrastructure monitoring and operation, infrastructure resource mobilization, and automated information exchange across machines and human resources, to enable different agencies to collaborate online.

An embodiment of the inventive concepts is a smart interoperable analytical platform capable of handling various kinds of infrastructure such as utility infrastructure (FIG. 8 (801)), IT infrastructure (FIG. 8 (802)) and other infrastructure elements (FIG. 8 (803)) etc., which are being interconnected with their specific sensing devices and are utilizing standard protocols for communications. Utility infrastructure predominantly comprises of assets such as DG set (FIG. 8 (804)), Precision AC (PAC) (FIG. 8 (805)), UPS (FIG. 8 (806)) respectively. IT infrastructure comprises of Racks (FIG. 8 (807)), Panels/power distribution units (PDUs) (FIG. 8 (808)), Switches (FIG. 8 (809)), and Servers (FIG. 8 (810)). etc. The other infrastructure elements comprises elements such as environmental sensors (FIG. 8 (811)) etc.

All these infrastructure assets communicate with their standard protocols through any of their respective communication media such as RS232, RS486, SNMP etc., with the smart inter operable analytical platform (FIG. 8 (812)).

The analytical process comprises of the following steps (i) Profiling of the infrastructure (FIG. 8 (813)), (ii) Referring to the base line standards (FIG. 8 (814)) of the respective infrastructure asset, (iii) Bench marking the report (FIG. 8 (815)) and developing the profile of the respective infrastructure, (iv) Analytical Process (FIG. 8 (816)) and (v) Developing Action engine (FIG. 8 (817)). The profiling of the infrastructure (FIG. 8 (813)) comprises of (i) energy profile (FIG. 8 (818)), (ii) operational profile (FIG. 8 (819)) and (iii) environmental profile (FIG. 8 (820)) etc., The energy profile (FIG. 8 (818)) is further processed in to qualitative and quantitative (FIG. 8 (821)) aspects. The operational profile (FIG. 8 (819)) interacts with data from information technology Infrastructure library (ITIL) tool/ERP tool (FIG. 8 (822)) and the environmental profile (FIG. 8 (820)) deals with the ambient parameters with respect to specific geographical location (FIG. 8 (823)).

The base line standards (FIG. 8 (814)) form the (i) bench mark comparatives with OEM specifications (FIG. 8 (824)), (ii) ISO/IEEE/ITIL standards (FIG. 8 (825)) and (iii) standard operating procedures (SOP) of enterprise (FIG. 8 (826)). Bench mark report (FIG. 8 (815)) produces report such as (i) ideal condition report (FIG. 8 (827)), (ii) current condition report (FIG. 8 (828)) and (iii) workable condition report (FIG. 8 (829)) respectively.

The analytics (FIG. 8 (816)) is the process of discovering, interpreting and communicating significant patterns it comprises of asset analytics (FIG. 8 (830)), cluster analytics (FIG. 8 (831)), floor/zonal analytics (FIG. 8 (832)) and overall, infra-analytics (FIG. 8 (833)) etc., Further the analytics process brings about meaningful findings such as (i) Power supply demand/usage analysis (FIG. 8 (834)) (ii) Equipment functionality analysis (FIG. 8 (835)) (iii) Resultant part analysis (FIG. 8 (836)) and (iv) Sustainability analysis (FIG. 8 (837)). The final outcome of the analytics results into, (i) historical analytical data (FIG. 8 (838)), (ii) current trend (FIG. 8 (839)), (iii) insights (FIG. 8 (840)), (iv) cause-effect analysis (v) (FIG. 8 (841)), (vi) what if analysis (FIG. 8 (842)), (vii) predictive analysis (FIG. 8 (843)), (viii) prescriptions and advises (FIG. 8 (844)) etc.

The action engine (FIG. 8 (817)) determines the final output of the smart interoperable analytical platform (FIG. 8 (812)). The outcome comprises of (i) publishing of results (FIG. 8 (845)) in the form of dashboard reports and graphical representation, (ii) exporting the results for third party consumption (FIG. 8 (846)) (iii) create actionable items (FIG. 8 (847)) and (iv) send control signals (FIG. 8 (848)) etc.,

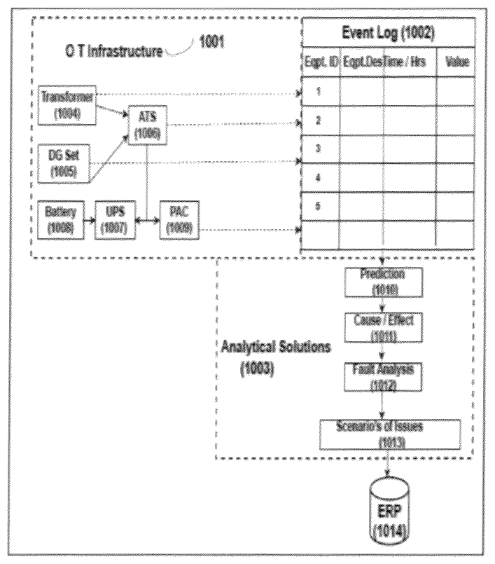

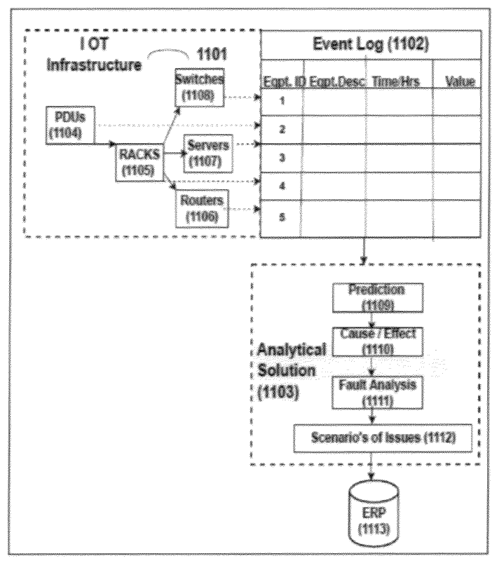

FIG. 9 (901 to 927) illustrates the capability of an embodiment of the inventive concepts for accurate analysis using Machine Learning models involving cross-domain collaborations between OT (FIG. 9 (901) & FIG. 10 (1001)), IOT (FIG. 9 (902) & FIG. 11 (1101)) and IT (FIG. 9 (903) & FIG. 12 (1201)) applications. The OT devices (FIG. 9 (901) & FIG. 10 (1001)) comprising of assets such as Transformer IT (FIG. 9 (905) & FIG. 10 (1004)), DG Set IT (FIG. 9 (906) & FIG. 10 (1005)), Automatic Transfer Switch (ATS) (FIG. 9 (907) & FIG. 10 (1006)) UPS (FIG. 9 (908) & FIG. 10 (1007)), Battery Bank (FIG. 9 (909) & FIG. 10 (1008)), Precision Air conditioner (PAC) (FIG. 9 (910) & FIG. 10 (1009)) etc., and IOT devices (FIG. 9 (902) & FIG. 11 (1101)) comprising of assets such as, Power distribution units (PDUs) (FIG. 9 (911) & FIG. 11 (1104)), Racks (FIG. 9 (912) & FIG. 11 (1105)), Servers (FIG. 9 (913) & FIG. 11 (1107)), Switches (FIG. 9 (914) & FIG. 11 (1108)) and routers (FIG. 9 (915) & FIG. 11 (1106)) etc.

The performance parameters of all these assets are monitored and recorded in the Event log (FIG. 9 (904)). The smart interoperable analytical platform produces analytics such as prediction (FIG. 9 (916)), cause/effect analysis (FIG. 9 (917)), fault analysis (FIG. 9 (918)) and scenarios of issues (FIG. 9 (919)) etc., The analytical outcome from the processed event log is further linked to IT applications (FIG. 9 (903) & FIG. 12 (1203)) such as Enterprise Resource Platform (ERP) (FIG. 9 (920) FIG. 12 (1208)) which in turn traces the assets in respect of (i) Asset value (FIG. 9 (921) & FIG. 12 (1209)), (ii) Service Level Agreement (SLA) (FIG. 9 (922) & FIG. 12 (1210)) (iii) Contract Terms & Conditions (FIG. 9 (923) & FIG. 12 (1211)) etc., After tracing of the assets the respective actions are initiated (FIG. 9 (924) & FIG. 12 (1212)) against each of the issues, the actions can be (i) replacement of parts (FIG. 9 (925) & FIG. 12 (1213)), (ii) Raising work order to the suppliers (FIG. 9 (926) & FIG. 12 (1214)), (iii) levy penalty (FIG. 9 (927) & FIG. 12 (1215)) to the service vendors in case of breach of SLA etc.,

FIG. 13 (1301 to 1318) illustrates process flow of Data Centre operations through AI/ML based cognitive capabilities of an embodiment of the inventive concepts through its Smart Interoperable Analytical platform, the challenges in data centre (FIG. 13 (1302) is generally about the issues faced by the users (FIG. 13 (1303) and generating work load (FIG. 13 (1304) for them, there are other infrastructure issues such as optimal utilization of server and network (FIG. 13 (1308), meeting the cooling demands (FIG. 13 (1305), efficiency and redundancy of UPS power supply (FIG. 13 (1307) and as a whole maintaining efficiency IT load factor (FIG. 13 (1306).

Uninterrupted Power supply and its efficiency plays major part in managing the data centre operations (FIG. 13 (1301). The input power supply is either from the utility grid (FIG. 13 (1312), or renewable energy/DG-set (FIG. 13 (1311). The power transfer happens between these two sources through main automatic transfer switch (ATS) (FIG. 13 (1310) which in turn feeds to cooling system (FIG. 13 (1309) and UPS. The data stream from the entire data centre (FIG. 13 (1301) infrastructure is fed to smart interoperable analytical platform (FIG. 13 (1313) which further process the informatics into various steps such as (i) profiling the infrastructure (FIG. 13 (1314) (ii) Benchmark the profile (FIG. 13 (1315) (iii) subjects to machine learning (ML) for the infrastructure analytics (FIG. 13 (1317) (iv) Creates action engine to deploy actionable intelligence (FIG. 13 (1318). Thus, the invention enables the data centre efficiency is management through its smart interoperable analytical platform.

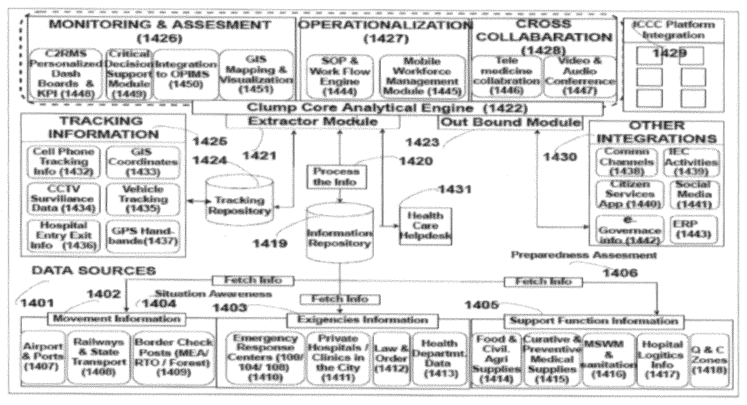

FIG. 14 (1401 to 1451) illustrates process flow for Emergencies: Crisis Control Response and Mitigation System (C2RMS) for various crisis scenarios. The crisis controls and response mitigation system (C2RMS) is a specialized operational capability of the invention. The system fetches information from the various data sources (FIG. 14 (1401)), there are three kinds of input data sources which gets fetched into the system such as (i) movement information (FIG. 14 (1402)) (ii) exigencies information (FIG. 14 (1403)) and (iii) support function information respectively. While data from movement information (FIG. 14 (1402)) and exigencies information (FIG. 14 (1403)) indicates the situational awareness (FIG. 14 (1404)) about the C2RMS at any given time, whereas data from support function information (FIG. 14 (1405)) indicates the preparedness assessment (FIG. 14 (1401)) for crisis response and mitigation capabilities of C2RMS.

The movement information (FIG. 14 (1402)) data is fetched from various means of transportation which are in service for the mobility of passengers and freight which includes information from (i) Airport & Sea port (FIG. 14 (1407)), (ii) Railways and State Road Transport (FIG. 14 (1408)), (iii) movements at border check posts (MEA/RTO/Hospitals) (FIG. 14 (1409)) etc., .Exigencies information (FIG. 14 (1403)) data is fetched from institutions/agencies/functionaries such as (i) emergency response centres (FIG. 14 (1410)), (ii) private hospitals and clinics in the city (FIG. 14 (1411)), (iii) Law & order departments (FIG. 14 (1412)), and (iv) health department data (FIG. 14 (1413)) respectively. Data form movement information (FIG. 14 (1402)) and exigencies information (FIG. 14 (1403)) helps to understand the situational awareness (FIG. 14 (1404)) on the other hand support functions information (FIG. 14 (1405)) helps to assess the extent of preparedness (FIG. 14 (1406)) to respond to any exigencies. The data from support functions (FIG. 14 (1405)) include (i) Food, Civil & agricultural supplies (FIG. 14 (1414)), (ii) Curative and preventive medical supplies (FIG. 14 (1415)), (iii) Municipal Solid Waste Management (MSWM) & Sanitation (FIG. 14 (1416)), (iv) Hospital logistics information (FIG. 14 (1417)) and (v) data from Q&C zones (FIG. 14 (1418)) respectively.

The information from the various data sources (FIG. 14 (1401)) and the preparedness assessment centres (FIG. 14 (1406)) is fetched and stored into information repository (FIG. 14 (1419)), from there the data gets further processed (FIG. 14 (1420)) and the processed data is fetched into extraction module (FIG. 14 (1421)) from there it is extracted into clump core analytical engine (FIG. 14 (1422)). The information from the extractor module is fed and stored into tracking repository (FIG. 14 (1424)) which enable the tracking of information (FIG. 14 (1425)). The extraction module also extracts data from health care exigencies helpdesk (FIG. 14 (1431)) etc., Clump core analytical engine (FIG. 14 (1422)) also gets information from outbound module (FIG. 14 (1423)) for integration of data from other sources (FIG. 14 (1430)) which are external to the C2RMS system. There are additional functional clusters of clump core analytical engine (FIG. 14 (1422)) namely Monitoring and Assessment (FIG. 14 (1426)), Operationalization (FIG. 14 (1427)), Cross collaboration (FIG. 14 (1428)) etc., The C2RMS is also integrated with Integrated Command Control Centres (ICCC) (FIG. 14 (1429)).

Tracking of information happens through various means of communication and traceability gadgets such as (i) Cell phones (FIG. 14 (1432)), (ii) Geographical Information System (GIS) coordinates (FIG. 14 (1433)), (iii) CCTV surveillance data (FIG. 14 (1434)), (iv) Vehicle tracking (FIG. 14 (1435)), (v) Hospital entry/exit information (FIG. 14 (1436)) and (vi) GPS hand-bands (FIG. 14 (1437)) respectively.

There are other integrations (FIG. 14 (1430)) are also linked to fetch information to outbound module (FIG. 14 (1423)), the external integrations comprise of (i) Communication channels (FIG. 14 (1438)), (ii) Information Education and Communication (IEC) activities (FIG. 14 (1439)), (iii) Citizen services App (FIG. 14 (1440)), (iv) social media (FIG. 14 (1441)), (v) e-governance (FIG. 14 (1442)) and ERP (FIG. 14 (1443)) respectively.

For operationalization (FIG. 14 (1427)) of the crisis control response & mitigation system (C2RMS) the platform is capable of creating the response SOP and workflow engine (FIG. 14 (1444)) and mobile workforce management module (FIG. 14 (1445)). The system is capable of cross collaborating between the departments, institutions and domines through audio/video conferencing (FIG. 14 (1447)) for services such as Telemedicine collaboration (FIG. 14 (1446)) and Graphic Information Systems (GIS) mapping & visualization (FIG. 14 (1451))

Finally, the monitoring and assessment of C2RMS is made possible through C2RMS personalized dash boards (FIG. 14 (1448)), critical decision support modules (FIG. 14 (1449)), integration to OPIMS (FIG. 14 (1450)) and Graphic Information System (GIS) Mapping & Visualization (FIG. 14 (1451))

FIG. 15 (1501 to 1515) illustrates the intelligent dash board for civil services under smart city project thus derive actionable insights for effective decision support and situational response. Unified operation and management platform (FIG. 15 (1501)) displays the capability of the inventions to integrate monitor and control multiple services such as smart bus system (FIG. 15 (1502)), power system (FIG. 15 (1503)), environmental sensor (FIG. 15 (1504)), Integrated traffic management system (ITMS) (FIG. 15 (1505)), water system (FIG. 15 (1506)), drinking water index (FIG. 15 (1507)), integrated building management system (IBMS) (FIG. 15 (1508)), CCTV system (FIG. 15 (1509)), sewage treatment plant (FIG. 15 (1510)), smart garbage bins (FIG. 15 (1511)), smart parking system (FIG. 15 (1512)), smart lighting system (FIG. 15 (1513)), and other graphical indicators such as revenue index (FIG. 15 (1514)) and liveability index (FIG. 15 (1515)) respectively. Hence the interoperable analytical platform is capable of integrating multiple system under one roof for monitoring control of the service and maintain the efficiency factors.

FIG. 16 (1601 to 1612) illustrates the detailed parameters under each of the services of the intelligent dashboard for certain services covered under unified operation and management platform for services such as (i) smart bus system (FIG. 16 (1601)) which displays parameters (FIG. 16 (1602)) like total number of buses, status running or stopped etc., (ii) power system (FIG. 16 (1603)) displays instantaneous load in (KVAR), the details of total power and its distribution amongst various locations of the city with availability of spare power in units or percentage is also displayed (FIG. 16 (1604)) (iii) Environment sensors (FIG. 16 (1605)) displays the status of the air quality at the current situation in compared with permissible standards is indicated (FIG. 16 (1606)), the rating varies from good, very poor to severe etc., based on the recorded readings. (iv) The integrated traffic management system (ITMS) (FIG. 16 (1607)) displays the working condition of the various cameras connected to the system whether they are serviceable or defective (FIG. 16 (1608)). (v) The sewage treatment plant (FIG. 16 (1609)) covers the parameters (FIG. 16 (1610)) such as no. of plants and their operational capacity, average water processed, efficiency factors etc., (vi) Smart Garbage Bin system (FIG. 16 (1611)) indicates total number of bins available, details (FIG. 16 (1612)) of 100% filled, partially filled and empty bins are displayed

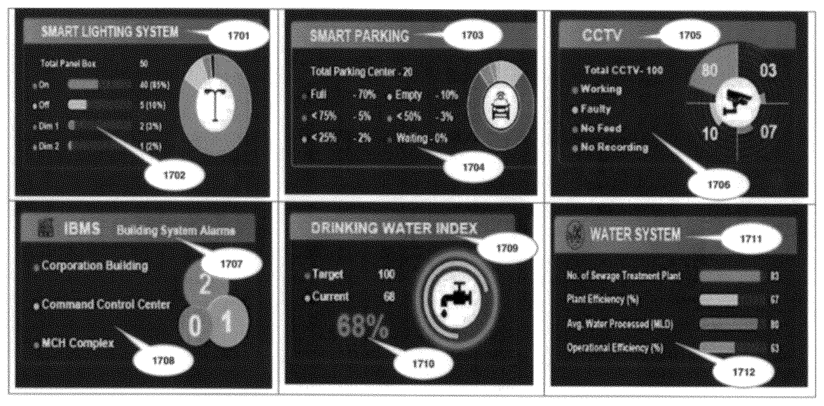

FIG. 17 (1701 to 1712) illustrates further details of intelligent dashboard for additional services covered under unified operation and management platform for services such as (i) Smart lighting system (FIG. 17 (1701)) which covers parameters such as switching ON/OFF conditions, lighting intensity (FIG. 17 (1702)) etc., (ii) Smart parking services (FIG. 17 (1703)) displays the details of total parking centres available, out of which how many or full, availability of vacant parking space etc., (FIG. 17 (1704)) (iii) CCTV system (FIG. 17 (1705)) displays the working condition of the cameras at various locations and also indicates the faulty cameras (FIG. 17 (1706)) (iv) Integrated Building Management System (IBMS) (FIG. 17 (1707)) identifies building alarms from various locations and zones such as corporation building, command control centre etc., (FIG. 17 (1708)) and activates follow up actions and mitigation methods. (v) Drinking water Index (FIG. 17 (1709)) indicates percentage of supply coverage (FIG. 17 (1710)) as against the demand (vi) Water system (FIG. 17 (1711)) accounts for number of sewage treatment plants, its efficiency factor, average water processed etc., (FIG. 17 (1712)). In this the invention being the interoperable analytical platform integrates the various services under one roof and enables efficient and effective operation and management under unified command and control system.

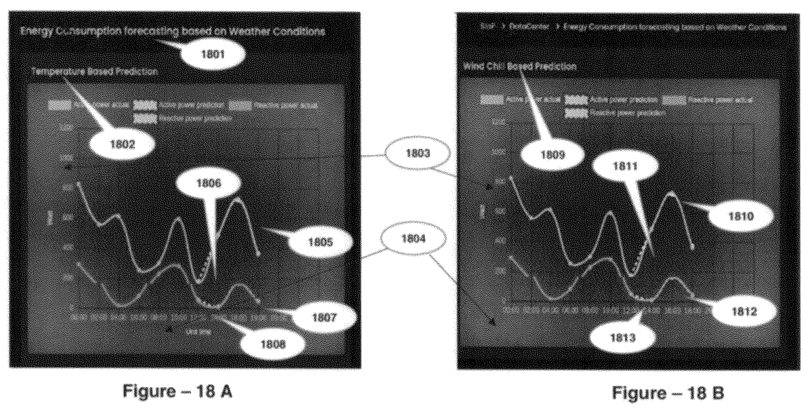

FIGS. 18A & B (1801 to 1814) illustrates the graphic display of the intelligent dashboard for the forecast of energy consumption predictions, (FIG. 18 (1801)) FIG. 18A displays the forecast based on weather conditions such as ambient temperature (FIG. 18 (1802)) and FIG. 18B displays the energy consumption forecast based on wind chill (cooling needs) (FIG. 18 (1809)) respectively. The graphic representation indicates the forecast readings in watts (FIG. 18 (1803)) as against hours of the day (FIG. 18 (1804)) the line graph indicates the two graphs one for active power actual (1805) another dotted line indicates active power predicted (1806) and another graph indicates reactive power actual (FIG. 18 (1807)) and reactive power predicted (FIG. 18 (1808)) respectively. FIG. 18 B displays the energy consumption as per cooling needs or windchill based predictions (FIG. 18 (1809)). The forecast displays the active power actual (FIG. 18 (18010)) and active power predicted (FIG. 18 (1811)) against the hours of the day. It also displays the graphic representation of reactive power actual (FIG. 18 (18012)) and reactive power predicted (FIG. 18 (1813)) respectively.

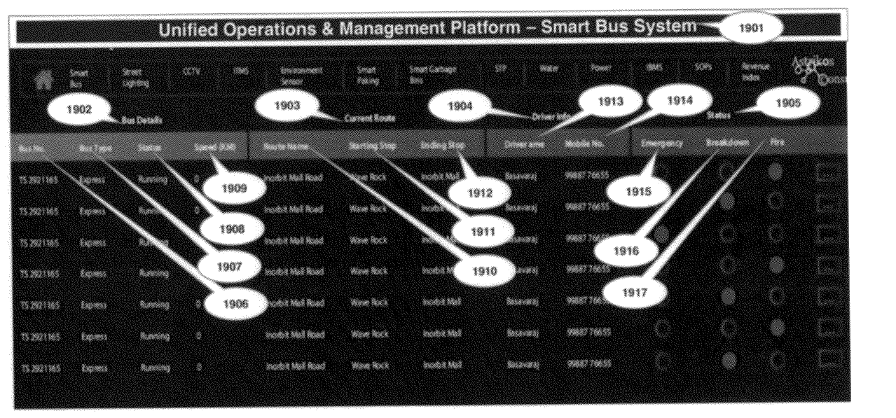

FIG. 19 (1901 to 1917) illustrates the screen shots of the intelligent dashboard for the services covered under unified operations and management platform indicating the parameters covered under smart bus system (FIG. 19 (1901)). The dashboard covers the parameters such as Bus details (FIG. 19 (1902)), current rout (FIG. 19 (1903)), driver information (FIG. 19 (1904)) and status of the bus (FIG. 19 (1905)) etc., The Bus details (FIG. 19 (1902)) comprises details such as Bus no. (FIG. 19 (1906)), Bus type (FIG. 19 (1907)) which indicates whether it is Ordinary or Express service, Status (FIG. 19 (1908)) indicating whether it is running or not running and the speed in Kilometres (FIG. 19 (1909)). The current route (FIG. 19 (1903)) contains details about route No. (FIG. 19 (1910)), starting point (FIG. 19 (1911)) and ending point (FIG. 19 (1912)) respectively. Under the driver info (FIG. 19 (1904)) the display covers the name of the driver (FIG. 19 (1913)) and is contact no. (FIG. 19 (1914)) for monitoring and contacting during emergencies. The Bus status (FIG. 19 (1905)) displays the conditions which makes the bus inoperative such as emergencies (FIG. 19 (1915)), breakdown (FIG. 19 (1916)) and Fire (FIG. 19 (1917)) respectively. Thus the intelligent dashboard displays the actual status of the bus running conditions and alerts responsible departments and support teams for appropriate actions thus bringing adequate safety, security, accountability and efficiency in the system.

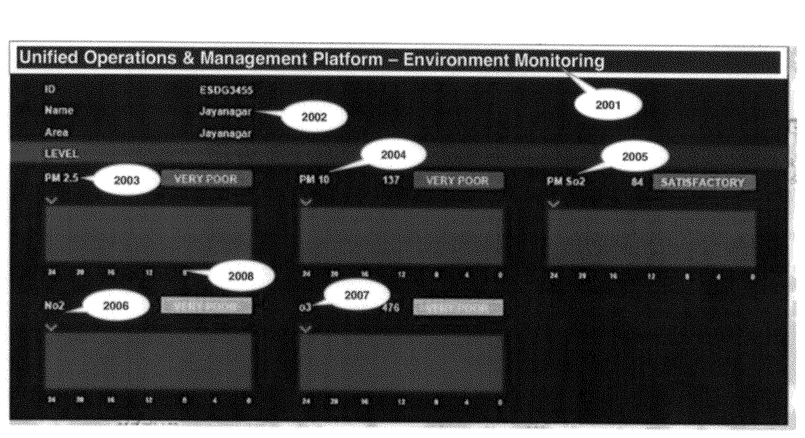

FIG. 20 (2001 to 2008) illustrates the screen shots of the intelligent dashboard of unified operations and management platform for environment monitoring (FIG. 20 (2001)) covering Ambient Air Quality parameter actual readings as against the standards with overall outcome indicated as satisfactory, poor or very poor respectively pertaining particular location (FIG. 20 (2002)). The parameters covered are (i) particulate matters PM 2.5 (microns) (FIG. 20 (2003)), particulate matters PM 10 (microns) (FIG. 20 (2004)), Sulphur-di-Oxide (SO2) (FIG. 20 (2005)), Nitrous Oxide (NO2) (FIG. 20 (2006)) and Ozone O3 (FIG. 20 (2007)) respectively. The representation of the parameters is monitored against hours of the day. (FIG. 20 (2008))

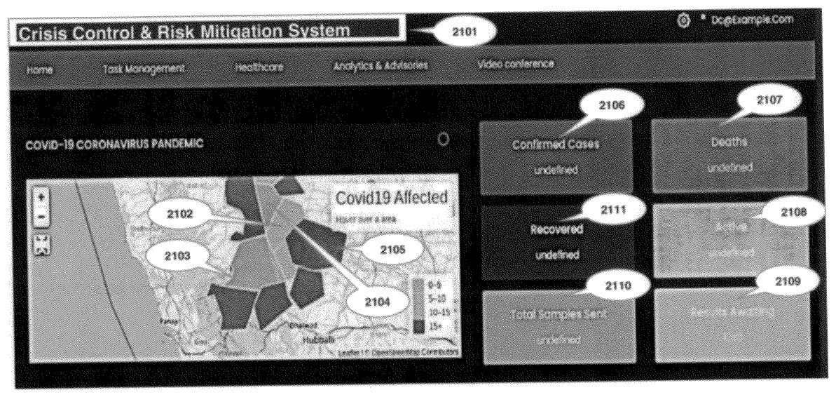

FIG. 21 (2101 to 2110) illustrates the intelligent dashboard display for the Crisis Control and Response Mitigation System (FIG. 21 (2101)) pertaining to Covid 19 pandemic situation. The display covers the Covid19 pandemic affected zones of a particular geographical area. The entire area is divided in to zones which is determined by the number of covid positive cases. The Green zone (FIG. 21 (2102)) denotes cases between 0 to 5, Yellow zone (FIG. 21 (2103)) for cases between 5 to 10, Amber zone (FIG. 21 (2104)) for cases between 10 to 15, Red zone (FIG. 21 (2105)) for cases above 15 respectively. There are other display parameters such as Total no. of confirmed cases (FIG. 21 (2106)), No. of deaths (FIG. 21 (2107)), No. of recoveries (FIG. 21 (2111)), No. of Active cases (FIG. 21 (2108)), Total sample sent (FIG. 21 (2110)), results awaited (FIG. 21 (2109)) etc., In this way the intelligent dashboard helps in managing the crisis scenarios such as Covid19 more effectively.

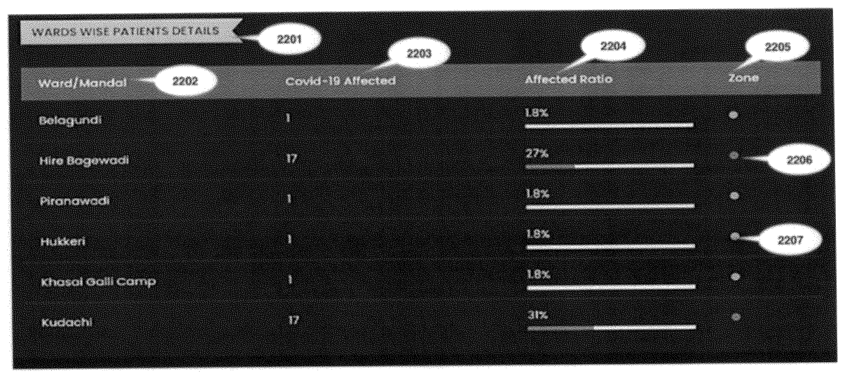

FIG. 22 (2201 to 2207) illustrates the screen shots of the intelligent dashboard indicating ward wise patent details (FIG. 22 (2201)) for the Crisis Control and Response Mitigation System pertaining to Covid 19 pandemic. The parameters such as the name of the ward (FIG. 22 (2202)), No. of Covid affected patients (FIG. 22 (2203)) against the respective ward, affected ratio (FIG. 22 (2204)) which displays the percentage affected with colour coding (FIG. 22 (2205)) displaying whether particular ward is coming under green (FIG. 22 (2206)), yellow, amber or red (FIG. 22 (2207)) respectively.

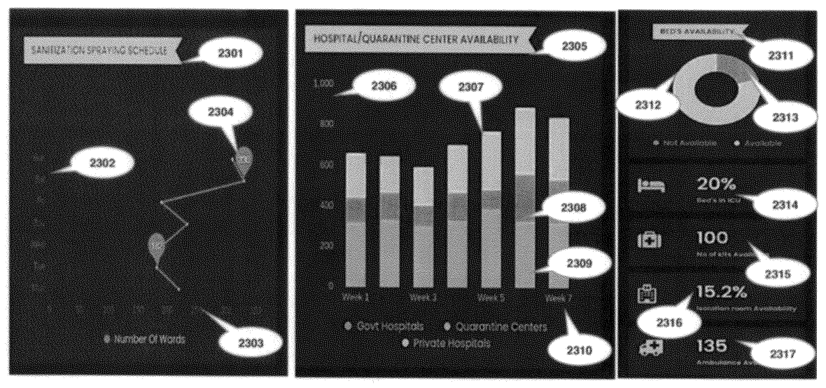

FIG. 23 (2301 to 2317) illustrates the screen shots of the intelligent dashboard for the Crisis Control and Response Mitigation System pertaining to Covid 19 pandemic preparedness such as planning the sanitation spraying schedule (FIG. 23 (2301)), Hospitals/quarantine centres availability (FIG. 23 (2305)), and availability of beds (FIG. 23 (2311)), health kits, ambulances etc., in various hospitals. Under the spraying schedule the dashboard displays the planning day (Monday to Sunday) (FIG. 23 (2302)) as against the respective ward No. scheduled (FIG. 23 (2303)) and also the ward no. of the particular spraying day is also displayed (FIG. 23 (2304)). The availability of quarantine centre/hospital (FIG. 23 (2305)) displays the numbers of hospital/quarantine centre available as against the odd no. of weeks (FIG. 23 (2310)). The red band displays number of government hospitals (FIG. 23 (2308)), the blue band indicates quarantine centres (FIG. 23 (2309)) and the green band indicates private hospitals (FIG. 23 (2307)) respectively.

The availability of Beds (FIG. 23 (2311)) is displayed along with additional parameters, in that green band indicates beds availability (FIG. 23 (2312)), red band indicates non-availability (FIG. 23 (2313)). Also finer details such as percentage of beds in ICU (FIG. 23 (2314)), number safety kits availability (FIG. 23 (2315)), percentage of isolation rooms availability (FIG. 23 (2316)) and also availability of ambulances (FIG. 23 (2317)) in these hospitals. Thus FIGS. 21 to 23 illustrates and displays the capability of the inventions in managing the covid19 emergencies efficiently and effectively through the crisis control response and mitigation system (C2RMS) platform.

Finally FIG. 24. (2401 to 2407) illustrates another scenario of the intelligent dashboard for the forecast and prediction of air quality which gets affected due to vehicular traffic it also compares the actual readings against the predicted readings. The graphic representation is about Traffic Vs Air Quality Indicators (AQI) (FIG. 24 (2401)), the two co-ordinates for the graph are month of the year (January to December) (FIG. 24 (2403)) and AQI (0-100 range) (FIG. 24 (2402)). The line graph with dotted yellow line (FIG. 24 (2405)) indicates predicted readings and line graph with continuous blue line indicates (FIG. 24 (2404)) actual AQI reading. In this way the system not only enables monitoring and controlling capabilities but also capable of accurate predictions which will enable to initiate pro-active corrective actions accordingly.

Thus, the invention is a collaborative, interoperable Analytical Platform for disparate specifics and provides advanced models and cognitive intelligence and intelligent dashboards to (a) manage and monitor cyber-physical equipment, (b) derive insights and hidden trends and patterns, and (c) predict possible scenarios and prescribe optimization strategies. This is achieved with a variety of communication protocols, instrumentation processes and models to optimize the operations of the infrastructure while automating situational monitoring and the response workflows.

The invention also has additional capabilities which can be explored on customizable implementation as per the need base analysis, the highlights are as follow:—
I. “Auto-pilot mode” intelligent process automation
II. Heuristic method based cognitive intelligence and action automation
III. Autocorrection based inquisitive model evaluation for model accuracy level (MAL) improvement
IV. Self-audit mechanism for thorough compliance abidance for the industry/global standard certified practices of heterogenous infrastructures.

### Advantages of the Invention

I. The invention can handle Multi-protocol Input, aggregating real-time information and specific parameters from systems e.g. IT/enterprise applications, or operational equipment, or sensors, and IoT-connected devices, machinery, etc.
II. Accurate analysis using Machine Learning models with cross-domain collaborations
III. Provides Process Automation in real time workflows for infrastructure monitoring and operation, infrastructure resource mobilization, and automated information exchange across machines and human resources, to enable different agencies to collaborate online
IV. Gives output in intelligent dashboards, thus derive actionable insights for effective decision support and situational response
V. Provide prescriptive advisories and alerts for operational strategies and infrastructure optimization

Thus, the invention enables multiple stakeholders and machines or equipment to collaborate effectively in ensuring intelligence infrastructure operations as it is both interoperable with, and agnostic to diverse specific information types and protocols that can cover entire Instrumentation-IT-OT-IOT landscape.

We claim:

1. A process for cognitive interoperable, source agnostic, infrastructure collaborative super diligence, said process comprising:
a) Input data informatics module (FIG. 2 (201)), to commence the process of receiving data from heterogenous agnostic sources (FIG. 2 (202)) having permissible access and security protocol clearance (FIG. 2 (203)) to undergo sequential processes comprising of:
i. user domain selection (FIG. 2 (204));
ii. data source selection (FIG. 2 (205));
iii. data extraction (FIG. 2 (206));
iv. checking (FIG. 2 (207)) suitability for cognitive Intelligence operations;
V. storing the data informatics in Big. data (FIG. 2 (209)) or cloud; and
vi. non-suitable data to undergo data cleansing, extraction, transformation (FIG. 2 (208)) and loading before being stored in Big. data (FIG. 2 (209)) for further processing;
b) Followed by process for model analysis (FIG. 2 (210)) to initiate machine learning (ML), comprising core learner module (FIG. 2 (211)) and core analytical engine module (FIG. 2 (215));
i. The core learner module (FIG. 2 (211)) consists of KPI analytics (FIG. 2 (212)), ML workbench (FIG. 2 (213)) and compliance standard analytics processes (FIG. 2 (214)) and;
ii. Core analytical engine module (FIG. 2 (215)) consists of analytical engine canned (FIG. 2 (216)), analytical engine custom (FIG. 2 (217)) and analytical engine compliance processes (FIG. 2 (218));
c) After model analytics the data informatics undergoes model testing and evaluation process (FIG. 2 (219)), model testing process (FIG. 2 (220)) determines the model accuracy level (MAL), for MAL >50% passes through model evaluation pipeline (FIG. 2 (221)) and further to model reverification process (FIG. 2 (222)), where scope for improvement ratio (SIR) is evaluated, for SIR <5% the output goes for result publishing (FIG. 2 (225)) and further processing;
d) Finally, results publishing (FIG. 2 (225)) and result visualization process (FIG. 2 (226)) comprising of:
i. outputs such as dashboards for analysis (FIG. 2 (225));
ii. results for user-defined studies;
iii. standard domain-specific metrics, which include options for correlative, predictive and prescriptive studies;
iv. option for the work flow items (FIG. 2 (229)) to be further processed for controlling machinery, equipment (FIG. 2 (224)) and any of the process engineering requirement;
v. outputs can also be exported for third-party requirements (FIG. 2 (227)) such as instrumentation/hardware/software/electronic systems consumption etc.

2. The process as claimed in claim 1, infrastructure include IT/OT/IoT devices (FIG. 8 (801, 802 & 803)) & (FIG. 9 (901,902 & 903)) and equipment fully integrated for seamless, collaborative operational intelligence.

3. The process as claimed in claim 1, infrastructure super diligence, include process for handling of public health and emergencies through crisis control, response and mitigation system (C2RMS) (FIG. 14. (1401 to 1451)).

4. The process as claimed in claim 1, Input data informatics module processing (FIG. 2 (201)) & (FIG. 3 (301)) comprises of:
a. all the complexities of cross-system interactions and heterogeneity of information specifics (FIG. 2 (202)), under wide array of protocols for communication (FIG. 3 (304)) and;
b. provisioning of correlative analytics across disparate IT/OT/IoT (FIG. 9) derived information specifics streams and across stakeholders, where both operational equipment (OT) and ICT infrastructure, are concurrently monitored and managed.

5. The process as claimed in claim 1, model analysis (FIG. 2 (210)) provides integrated analytics solution (FIG. 8 (812)) wherein information specifics from diverse operational equipment (FIG. 8 (801,802 & 803)) is extracted to yield actionable insights and advisories for stakeholders across all functions and domains for infrastructure such as smart cities, data centres, urban/rural infrastructure, campuses, sea/air-ports, rail networks, energy/utilities, or industries etc.

6. The process as claimed in claim 1, the benchmark data provided by ML workbench (FIG. 2 (213)), sets in operational technology and enable analytics across cyber-physical operations and provide comprehensive portfolio to mine raw analogue data and also provide insights as well as advisories in response to events.

7. The process of claim 1, the core learner module includes (FIG. 2 (211)) & FIG. 3 (311)) user intervention, user defined analytical modules (FIG. 3 (313)) etc.

8. The process as claimed in claim 1, activities under standard KPI analytics (FIG. 2 (212)) comprises of carrying out pre-operations by arranging ML based analytics (FIG. 3 (311)) on industry standard KPIs according to the relevance to the respective infrastructure (FIG. 8 (814 & 824)) such as smart cities, data centres, and industries etc.

9. The process as claimed in claim 1, compliance standard analytics process includes analysis and comparison of standards such as ISO, LEED, WELL, WCM, Tier-Standards, IEEE etc.

10. The process as claimed in claim 1, the core learner module involves technological suggestions (FIG. 3 (315)) comprising of statistical analytical processes such as regression analysis (FIG. 3 (316)), predictive analysis (FIG. 3 (317)), descriptive analysis (FIG. 3 (318)), actionable insights (FIG. 3 (319)) and study of historical data (FIG. 3 (320)) as applicable.

11. The process as claimed in claim 1, the core analytical engine module (FIG. 2 (215)) & FIG. 3 (321)) includes selection of specific type of suitable engine (FIG. 3 (323)) from the array of algorithmic programs FIG. 3 (324)) and reinforced module analysis engine (FIG. 3 (325)).

12. The process as claimed in claim 1, the analytical engine for canned (FIG. 2 (216)) & FIG. 3 (312)) comprises of:
a. model definition;
b. providing system Input for training;
c. comparative analytics to compliance standards/benchmark values;
d. predict and also harness prescriptions to improvements and;
e. Carrying out multiple iterations to fine tune the model to get the optimal and accurate values.

13. The process as claimed in claim 1, the analytical engine for customs (FIG. 2 (217)), FIG. 3 (321), FIG. 5 (508)) comprises of;
a. User Input of training specifics;
b. System suggested model definition;
c. Method for selection by user and submitting of multiple iterations to fine tune the model;
d. Finally process for deployment of database or export result.

14. The process as claimed in claim 1, the analytical engine for compliance comprises of:
a. Model definition (FIG. 2 (218) & FIG. 5 (509));
b. Providing system input of training information specifics;
c. “What-if” simulators;
d. Comparative analytics to past models;
e. Predictive models for future values and;
f. Multiple iterations to fine tune the model.

15. The process as claimed in claim 1, the model testing and evaluation (FIG. 2 (219) & FIG. 6 (602)), is processed in model evaluation pipeline (FIG. 2 (221)), the process comprising of activities such as:
a. model verification with reverse traversal;
b. comparative checks with benchmark value and comparative analysis with industry standards and;
c. finally, estimation of scope for improvement rate (SIR Value) etc.

16. The process as claimed in claim 1, the result visualization process (FIG. 2 (226) & FIG. 7 (705)) provides seamless and interactive user interface for Visual Analytics (FIG. 2 (225)) with guidance for decision support under uncertainty and also provide insights into unknown scenarios.

17. The process as claimed in claim 1, the workflow items are further processed to address, real-time situational response strategies and automated intelligent advisories with collaborative workflows (FIG. 2 (229)), where events can trigger alerts and work orders and raise context-sensitive intelligent alarms (FIG. 2 (228)) and online real-time information exchange, resulting in quick decisions and optimal cross-functional response.

18. A System for cognitive interoperable source agnostic infrastructure collaborative super diligence, comprising:
a. Input data informatics module system (FIG. 2 (201)) capable of receiving data from heterogenous agnostic sources (FIG. 2 (202)) such as live streams (FIG. 3 (302)), flat files (FIG. 3 (303)), protocols (FIG. 3 (204)), images and multimedia etc., (FIG. 3 (205)), through permissible access and security protocol clearance (FIG. 2 (203)), the system undertakes:
i. User domain selection (FIG. 2 (204));
ii. Data source selection (FIG. 2 (205));
iii. Data extraction (FIG. 2 (206)) and;
iv. Checks suitability (FIG. 2 (207)) for input to cognitive Intelligence before storing it in Big. data (FIG. 2 (209)) or cloud;
v. the non-suitable data passes through a system to undergo data transformation (FIG. 2 (208)) which includes;
1. Means for data cleansing;
2. Pre-processing consisting of means for extraction, transformation and loading before being stored in Big. data (FIG. 2 (209)) for further processing;
b. System for Model analysis (FIG. 2 (210)) for machine learning, comprising of core learning module (FIG. 2 (211)) and core analytical engine module (FIG. 2 (215));
i. The system for core learning module (FIG. 2 (211)) consists of system for KPI analytics (FIG. 2 (212)), ML workbench (FIG. 2 (213)) and compliance standard analytics (FIG. 2 (214));
ii. The system for core analytical engine module (FIG. 2 (215)) consists of system for analytical engine canned (FIG. 2 (216)), analytical engine custom (FIG. 2 (217)) and analytical engine compliance (FIG. 2 (218));
c. System for Model testing (FIG. 2 (219)), and evaluation (FIG. 2 (220)), includes model evaluation pipeline (FIG. 2 (221)) and means for model reverification (FIG. 2 (222)) and means to pass the output for publishing (FIG. 2 (225)), and further processing;
d. System for results publishing (FIG. 2 (225)), and result visualization (FIG. 2 (226)), comprises of various types of output system integration such as:
i. Dashboard display for analysis;
ii. Means for providing results of user-defined studies or standard domain-specific metrics or options for correlative, predictive or prescriptive studies;
iii. The system also provides work flow items (FIG. 2 (229)) with options for controlling machinery/equipment (FIG. 2 (224)), and any of the process engineering requirement;
iv. Finally, there is an option to export these outputs for third-party requirements (FIG. 2 (227)), such as instrumentation/hardware/software/electronic systems consumption.

19. The System as claimed in claim 18, Input data for informatics (FIG. 3 (301)) contain agnostic data (FIG. 3 (302)) and means for ingestion modelling (FIG. 3 (306)).

20. The system as claimed in claim 19, further to ingested modelling the data (FIG. 3 (306)) is passed through means for data sanitizing (FIG. 3 (307)) which comprises of:
a. System for filtering and loading (FIG. 3 (308)) and;
b. Means for classification (FIG. 3 (309)), allocation and tagging (FIG. 3 (310)) simultaneously.

21. The system as claimed in claim 18, the infrastructure includes IT/OT/IoT devices (FIG. 8 (801, 802 & 803)) & (FIG. 9 (901,902 & 903)) and equipment being fully integrated for seamless, collaborative operational intelligence.

22. The system as claimed in claim 18, infrastructure super diligence, include handling of public health and emergencies through crisis control, response and mitigation system (C2RMS) (FIG. 14. (1401 to 1451)).

23. The system as claimed in claim 17, Input data informatics module (FIG. 2 (201)) & (FIG. 3 (301)) comprises;
a. A system to address all the complexities of cross-system interactions and heterogeneity of information specifics (FIG. 2 (202)), under wide array of protocols for communication (FIG. 3 (304)) and;
b. A system to provide correlative analytics across disparate IT/OT/IoT derived information specifics streams and across stakeholders, where both operational equipment (OT) and ICT infrastructure, are concurrently monitored and managed.

24. The system as claimed in claim 18, the system for model analysis (FIG. 2 (210)) provides integrated analytics solution (FIG. 8 (812)) wherein information specifics from diverse operational equipment is extracted (FIG. 8 (801,802 & 803)) to yield actionable insights and advisories for stakeholders across all functions and domains for infrastructure such as in smart cities (FIG. 15), data centers (FIG. 13), urban/rural infrastructure, campuses, sea/air-ports, rail networks, energy/utilities, or industries etc.

25. The system as claimed in claim 18, the core learner module (FIG. 2 (211)) & FIG. 3 (311)) includes user intervention and also user defined analytical modules (FIG. 3 (313)).

26. The system as claimed in claim 18, activities under standard KPI analytics (FIG. 2 (212)) consists of carrying out pre-operations by arranging ML based analytics (FIG. 3 (311)) on industry standard KPIs according to the relevance to the respective infrastructure (FIG. 8 (814 & 824)) such as smart cities (FIG. 15), data centers (FIG. 13), and industries etc.

27. The system as claimed in claim 18, the core learner module involves system for technological suggestions (FIG. 3 (315)) comprising means for statistical analysis such as:
a. regression analysis (FIG. 3 (316));
b. predictive analysis (FIG. 3 (317));
C. descriptive analysis (FIG. 3 (318));
d. actionable insights (FIG. 3 (319)) and;
e. study of historical data (FIG. 3 (320)) etc.

28. The system as claimed in claim 18, the core analytical engine module (FIG. 2 (215)) & FIG. 3 (321)) includes means for selection of specific type of suitable engine (FIG. 3 (323)) from the array of algorithmic programs (FIG. 3 (324)) and reinforced module analysis platform (FIG. 3 (325)).

29. The system as claimed in claim 18, the analytical engine for canned (FIG. 2 (216)) & FIG. 3 (312)) comprises:
a. Means for model definition;
b. Provisioning of system Input for training;
C. Provisioning of system for comparative analytics of compliance standards and benchmark values;
d. System to predict and also provide means to harness prescriptions to improvements and;
e. System to undertake multiple iterations to fine tune the model to get the optimal and accurate values.

30. The system as claimed in claim 18, the analytical engine for customs (FIG. 2 (217)), FIG. 3 (321), FIG. 5 (508)) comprises of:
a. user Input means of training specifics;
b. system suggested model definition;
C. means for selection by user and submitting of multiple iterations to fine tune the model and;
d. finally provide means for deployment of database or export result.

31. The system as claimed in claim 18, the analytical engine for compliance comprises of:
a. Model definition means (FIG. 2 (218) & FIG. 5 (509));
b. System input of training information specifics;
C. Provisioning of “What-if” simulators;
d. Means to provide comparative analytics to past models;
e. Provisioning of predictive models for future values and;
f. Finally means for multiple iterations to fine tune the model.

32. The system as claimed in claim 18, for model testing and evaluation (FIG. 2 (219) & FIG. 6 (602)), the means for evaluation is provided in model evaluation pipeline (FIG. 2 (221)) comprising of:
a. means for model verification with reverse traversal;
b. Means for comparative analysis with benchmark value and industry standards and;
C. finally provisioning of means for estimation of scope for improvement rate (SIR Value) etc.

33. The system as claimed in claim 18, the result visualization (FIG. 2 (226) & FIG. 7 (705)) provides means for seamless and interactive user interface for Visual Analytics (FIG. 2 (225)) with guidance for decision support under uncertainty and also provide insights into unknown scenarios.

34. The system as claimed in claim 18, the workflow items further provide:
a. Means to address real-time situational response strategies and automated intelligent advisories;
b. Provisioning of means for collaborative workflows (FIG. 2 (229)), where events can trigger alerts to enterprise resource platforms (ERP) (FIG. 9 (920)) for;
i. initiating work orders (FIG. 9 (926));
ii. raise context-sensitive intelligent alarms (FIG. 2 (228)) and;
iii. provide means for online real-time information exchange, resulting in quick decisions and optimal cross-functional response.

35. A method of cognitive interoperable source agnostic infrastructure collaborative super diligence, comprising:
receiving data from heterogeneous agnostic sources having permissible access and security protocol clearance to undergo sequential processes comprising: selecting user domain; selecting data source; extracting data; checking suitability for cognitive intelligence operations; storing data informatics in cloud; and
cleansing non-suitable data, extracting, transforming and loading before being stored in Big Data for further processing;
analyzing models to initiate machine learning (ML) using a core learner module and a core analytical engine module, the core learner module consisting of standard KPI analytics, ML workbench and compliance standard analytics processes, and the core analytical engine module consisting of analytical engine for canned, analytical engine custom, and analytical engine compliance processes;
testing models to determine model accuracy level (MAL) and allowing passage through model evaluation pipeline for MAL >50%;
evaluating scope for improvement ratio (SIR) and determining output results for SIR <5%; and
publishing and visualizing the output results.

36. The method of claim 35, wherein the infrastructure includes IT/OT/IOT devices and equipment fully integrated for seamless, collaborative operational intelligence.

37. The method of claim 35, wherein the collaborative super diligence includes process for handling of public health and emergencies through crisis control, response and mitigation system (C2RMS).

38. The method of claim 35, wherein the core learner module includes user intervention, and user defined analytical modules.

39. The method of claim 35, wherein activities under standard KPI analytics comprises carrying out pre-operations by arranging ML based analytics on industry standard KPIs according to relevance to respective infrastructure such as smart cities, data centers, and industries.

40. The method of claim 35, wherein compliance standard analytics process includes analysis and comparison of standards such as ISO, LEED, WELL, WCM, Tier-Standards, and IEEE.

41. The method of claim 35, wherein the core analytical engine module includes selection of specific type of suitable engine from an array of algorithmic programs and reinforced module analysis engine.

42. The method of claim 35, wherein analyzing models further comprises providing integrated analytics solution wherein information specifics from diverse operational equipment is extracted to yield actionable insights and advisories for stakeholders across all functions and domains for infrastructure such as smart cities, data centers, urban/rural infrastructure, campuses, sea/air-ports, rail networks, energy/utilities, or industries.

43. The method of claim 35, wherein the analytical engine for canned comprises of: model definition; providing system Input for training; comparative analytics to compliance standards/benchmark values; predict and harness prescriptions to improvements and; carrying out multiple iterations to fine tune the model to get the optimal and accurate values.

44. The method of claim 35, wherein the analytical engine for compliance comprises of: model definition; providing system input of training information specifics; “What-if” simulators; comparative analytics to past models; predictive models for future values; and multiple iterations to fine tune the model.

45. A system for cognitive interoperable source agnostic infrastructure collaborative super diligence, comprising:
an input data informatics module system capable of receiving data from heterogeneous agnostic sources such as live streams, flat files, protocols, images and multimedia, through permissible access and security protocol clearance, the system undertakes: user domain selection; data source selection; data extraction; and
checks suitability for input to cognitive Intelligence before storing it in Big Data or cloud, the non-suitable data passes through a system to undergo data transformation;
a model analysis system for machine learning comprising a core learning module and a core analytical engine module, the core learning module consisting of system for KPI analytics, ML workbench and compliance standard analytics; and the core analytical engine module consists of system for analytical engine canned, analytical engine custom and analytical engine compliance; and
a results publication and results visualization system.

46. The system as claimed in claim 45, wherein the model analysis system provides integrated analytics solution wherein information specifics from diverse operational equipment is extracted to yield actionable insights and advisories for stakeholders across all functions and domains for infrastructure such as in smart cities, data centers, urban/rural infrastructure, campuses, sea/air-ports, rail networks, energy/utilities, or industries.

47. The system as claimed in claim 45, the core learner module involves system for technological suggestions comprising means for statistical analysis such as: regression analysis, predictive analysis, descriptive analysis, actionable insights, and study of historical data.
